(19) United States
(12) Patent Application Publication
(10) Pub. No.: US 2024/0065160 A1
(43) Pub. Date: Feb. 29, 2024

(54) SYSTEM FOR DETERMINING A CROP EDGE AND SELF-PROPELLED HARVESTER

(71) Applicant: CLAAS Selbstfahrende Erntemaschinen GmbH, Harsewinkel (DE)

(72) Inventors: Sven Carsten Belau, Gütersloh (DE); Christoph Heitmann, Warendorf (DE); Dennis Neitemeier, Lippetal (DE); Ingo Bönig, Gütersloh (DE)

(73) Assignee: CLAAS Selbstfahrende Erntemaschinen GmbH, Harsewinkel (DE)

(21) Appl. No.: 18/237,954

(22) Filed: Aug. 25, 2023

(30) Foreign Application Priority Data
Aug. 25, 2022 (DE) 10 2022 121 482.6

(51) Int. Cl. A01D 43/08; A01B 69/00; A01B 69/04

(52) U.S. Cl. CPC A01D 43/085; A01B 69/001; A01B 69/008

(57) ABSTRACT

A system for determining a crop edge and a self-propelled harvester using the system for automatic control are disclosed. The system comprises a camera that generates optical information of a front environment of the harvester. The system further includes a computing unit that analyzes the images using artificial intelligence so that a planted area of a field on which a plant crop is located may be delimited from a remaining residual area of the field, thereby determining the plant crop. In turn, the computing unit is further configured to determine the crop edge of the plant crop based on the determination of the plant crop and to automatically control the harvester based on the determination of the crop edge.

### CROSS REFERENCE TO RELATED APPLICATION

This application claims priority under 35 U.S.C. § 119 to German Patent Application No. DE 10 2022 121 482.6 filed Aug. 25, 2022, the entire disclosure of which is hereby incorporated by reference herein.

### TECHNICAL FIELD

The present invention relates to a system for determining a crop edge and a self-propelled harvester.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Self-propelled harvesters may generally be used to work fields. There are various types of harvesters, such as combine harvesters (also known as combines) and forage harvesters, wherein the latter is configured to pick up and comminute harvested material such as grass, alfalfa or corn. In every case, the harvester is typically manually steered into a plant crop (interchangeably termed plant crop or plant population) so that the harvester can process the harvested material.

EP 3 300 561 A1 discloses a self-propelled agricultural machine that is intended to enable a crop edge of a field crop to be determined using a laser sensor. The laser sensor scans a surrounding area of the production machine and determines an existing lane based on sensor data.

### BRIEF DESCRIPTION OF THE DRAWINGS

The present application is further described in the detailed description which follows, in reference to the noted drawings by way of non-limiting examples of exemplary implementation, in which like reference numerals represent similar parts throughout the several views of the drawings, and wherein:

FIG. 1 illustrates a side view of one example of a self-propelled harvester.

FIG. 2 illustrates a visualization of a semantic image segmentation of a plant crop.

FIG. 3 illustrates another visualization of semantic image segmentation of the plant population.

FIG. 4 illustrates a schematic view of the system.

### DETAILED DESCRIPTION

As discussed in the background, the harvester is typically manually steered into a plant crop so that the harvester can process the harvested material. However, to the extent that a steering angle of the harvester is manually adjusted when steering into the plant crop, there may be a risk that individual rows of plants will be left standing or that a cutting unit width of the harvester will not be fully utilized. In addition, manual steering may require continuous input from a driver of a harvester, which may result in human error. In turn, this may result in the field being incorrectly processed, which may make it necessary to process the left plant rows a second time.

Further, as discussed in the background, systems may use a laser sensor. However, relying on a laser sensor can be very expensive.

Thus, in one or some embodiments, a system is disclosed that comprises a computing unit and at least one camera. For the purposes of the present invention, a “camera” may be understood to be any optical sensor that outputs at least two-dimensional sensor data. In this context, the camera may be configured to capture and/or generate optical sensor data in the form of one or more discrete images. The camera may be a conventional camera. Alternatively, the camera may comprise a LIDAR sensor. In particular, the camera may be configured to capture images of a front environment of an agricultural harvester (e.g., images of an environment located in front of the harvester when the harvester is operating as viewed in a direction of travel of the harvester).

In one or some embodiments, the data captured by the camera may be fed or transmitted to the system's computing unit. For this purpose, the computing unit and the camera may be connected to or in communication with each other (e.g., wired and/or wirelessly) so as to transmit data. For example, the camera and the computing unit may be connected to each other via cable. Alternatively, or in addition, a wireless connection, such as using Bluetooth, is also contemplated.

In one or some embodiments, the computing unit may be configured to process at least one of the images generated by the camera in such a way that a planted area of a field on which the plant crop is located may be delimited from a remaining area of the field. In this regard, the computing unit may be configured to analyze at least one of the one or more discrete images in order to identify a plant crop by using artificial intelligence to delimit a planted area of a field on which the plant crop resides from a remaining residual area of a field. In one or some embodiments, a “plant area” (or “planted area”) may comprise an area in which a “plant crop” is located. The plant crop may be, for example, grain or another crop to be harvested using the agricultural harvester, such as grass, alfalfa or corn. The planted area may be distinct from “residual area,” which may be the area where there is no plant crop. For example, the residual area may be an area that has already been harvested, so that it is formed only by acreage and/or remnants of plant parts such as stalks.

In one or some embodiments, the computing unit uses artificial intelligence in order to demarcate, segment and/or identify the planted area from the residual area. For example, the plant crop may be determined as a result of the demarcation of the planted area from the residual area. In turn, as a result of determining the plant crop, the computing unit may determine the crop edge of the plant crop. In one or some embodiments, “crop edge” may comprise the boundary between the planted area and the residual area.

In one or some embodiments, the system disclosed may have numerous advantages. In particular, the system may enable determination of a crop edge of a plant crop. In turn, information about the plant crop may be used (such as by the computing unit) in order to easily and precisely automatically steer an agricultural harvester into the crop edge so that the plant crop may be completely processed or harvested by the harvester. In this way, the efficiency of the harvester may be improved. The use of a camera may be significantly less expensive than the use of a laser sensor described in the prior art. Using the determined crop edge of the plant crop, an agricultural harvester (using the computing unit) may thus automatically steer into the plant crop particularly well, which may prevent the omission of individual plant rows. As such, the harvester may, on the one hand, operate more efficiently. On the other hand, individual areas may not need to be driven over twice in order to process remaining plant rows.

In one or some embodiments, the artificial intelligence comprises a trained neural network. In one or some embodiments, the use of a neural network may be particularly suitable for determining the crop edge. The use of a trained neural network may also be known as deep learning. However, other types of artificial intelligence are also contemplated.

In one or some embodiments, the computing unit is configured to perform a segmentation of individual images by means of which content of a particular image may be divided into adjoining segments (e.g., interrelated segments). During the segmentation, regions with related content may be generated by a combination of neighboring pixels of the image according to a certain homogeneity criterion. For this purpose, the front environment of the agricultural production machine may first be captured using the camera, thereby generating images of the front environment. Then, the computing unit may segment the images, and in turn, the computing unit may extract certain features from the segmented images. Based on the features extracted, the computing unit may classify the images in order for the computing unit to draw one or more conclusions about the respective image.

In one or some embodiments, the computing unit is configured to semantically segment individual images, wherein segments, such as adjacent segments, may be assigned to different classes. In one or some embodiments, one class is “plant crop” and another class is “background”. The division into the classes of “plant crop” and “background” may enable the demarcation between the planted area and the remaining area so that the planted area of the field may be determined. In one or some embodiments, a neural network may be used for this classification purpose, so that the neural network is trained in advance to perform such classification. In one or some embodiments, the neural network has been supplied with corresponding image data in order to perform the training. The neural network may, for example, be UNET with a mobileNET or mobileNETV2 architecture. Other neural networks are contemplated.

In one or some embodiments, the computing unit is configured to define a polygon along the crop edge. In one or some embodiments, the computing unit may also be configured to define the polygon along a segment boundary between the segments of the classes “plant crop” and “background”. Since the plant crop may not form an ideal geometric shape, the definition of a polygon may be particularly good for determining the edge of the crop. In one or some embodiments, if several small polygons with the class of “plant crop” are identified, the neural network may be trained to consider only the polygon which has the largest area since this may most likely be the plant crop to be harvested, and not a green strip adjacent to the field.

In one or some embodiments, the computing unit is configured to determine a reference point of the polygon which, viewed in an image area of the particular image, has a largest or a smallest sum of an x-pixel coordinate and a y-pixel coordinate relative to a defined coordinate cross, wherein the coordinate cross defines an x-axis in the horizontal direction and a y-axis in the vertical direction with reference to the particular image, starting from a zero point. For this purpose, a coordinate system may be assigned to the image recorded by the camera with its pixels, wherein the pixels may each be assigned an x- and a y-pixel coordinate. In this way, each pixel in the image may be uniquely named. Since the field to be harvested may usually, as seen from the camera's point of view, be a contiguous area, wherein a crop edge into which the harvester is to steer into is typically located either in a bottom left or a bottom right corner of the captured image, it may be advantageous to determine the crop edge as a pair of pixels of the previously determined polygon whose sum of the pixel coordinates is the smallest. However, it is also contemplated to determine the pair of pixels whose sum of pixel coordinates is the largest. A decision on whether the smallest or largest sum should be used to determine the reference point may depend essentially on the arrangement of the coordinate cross in the image.

In one or some embodiments, the system may have an entry unit through which entries may be made for further processing using the computing unit. In one or some embodiments, the entry unit may be configured to define the coordinate cross alternately at different locations and with different orientations of the x-axis and/or the y-axis, wherein the coordinate cross may be definable in a bottom left corner of the particular image with the x-axis in a horizontal direction to the right and the y-axis in a vertical direction upwards, or in a lower right corner of the particular image with the x-axis in a horizontal direction to the left and with the y-axis in a vertical direction upwards. In one or some embodiments, the entry unit may comprise a touchscreen or the like. As mentioned above, the crop edge of the plant crop may generally be located in a bottom left or right corner of the field of view of a camera. In order to use the above described determination of the crop edge by finding the pair of pixels whose sum is the smallest, the definition of the coordinate crosses at the bottom two corners has proven to be particularly advantageous. However, it is also contemplated to place the coordinate cross at a point in the image and then perform a coordinate transformation. In one or some embodiments, the system may identify a left as well as a right crop edge of the plant crop. In one or some embodiments, a driver of the harvester may select the appropriate setting (e.g., via the touchscreen) depending on a position of the camera before the system is to identify the crop edge.

In one or some embodiments, the computing unit is configured to define the crop edge at the reference point, wherein the crop edge may extend in the vertical direction starting from the reference point. Since a corner point of the crop edge may generally be arranged or positioned in the field of view of the camera in a bottom left or a bottom right corner and the crop edge extends from the corner point in a vertical direction, which may also correspond to the direction of travel of the harvester, the definition of the reference point from which the crop edge extends in a vertical direction may be particularly advantageous. However, the crop edge need not have to extend only in a vertical direction in every case. Likewise, the crop edge in the field of view of the camera may be oriented at an angle to the vertical direction.

Furthermore, in one or some embodiments, the computing unit is configured to execute a steering algorithm in order to automatically steer the harvester. In particular, the computing unit may be configured to generate one or more control signals in order to control (e.g., steer) the harvester. The computing unit may also be configured to transfer the crop edge to the steering algorithm and to process this or these using the steering algorithm in such a way that the harvester automatically enters the plant crop and/or automatically maintains a path when driving into the plant crop. In this way, the system may assist the driver of the harvester not only in automatically driving into the crop edge, but also in the subsequent automatic processing of the plant crop. In one or some embodiments, the driver may therefore be continuously helped, so that errors with regard to steering the harvester may be reduced. In one or some embodiments, the system may additionally use data (e.g., location data) from a GPS system or may be combined with row scanners. In this context, it may be particularly advantageous if the driver approaches the plant crop with the harvester in such a way that it appears in a field of view of the camera. Depending on the position of the camera, the plant crop may be located in a left or right edge of the particular image captured by the camera. After entering the position of the camera using the entry unit, the driver may then activate the system, which may automatically identify the plant crop and the crop edge and automatically (e.g., without manual intervention) drive the harvester into the crop edge and then may also automatically steer the harvester independently over the plant crop.

In one or some embodiments, a self-propelled harvester is disclosed to work with (or have as a part of it) the system described above. The self-propelled harvester, which may comprise a self-propelled forage harvester, may include a cutting unit for cutting plants standing on a field and at least two pivotable round wheels which may be in contact with ground and whose position may be changed for the purpose of changing a direction of travel of the harvester. Thus, the self-propelled harvester may include a computing unit of the system that is configured to automatically control (e.g., using one or more control signals) the pivotable round wheels depending on a certain crop edge of a plant crop to be harvested using the harvester so that an alignment of the harvester relative to the plant crop may occur automatically.

In one or some embodiments, the self-propelled harvester may have one or more advantages. In particular, the harvester may enable a plant crop to be approached automatically (e.g., without manual intervention). In this way, a driver of the harvester may receive assistance in driving the harvester into the plant crop. Advantageously, errors may be reduced or avoided while driving, thereby avoiding driving over the plants a second time. The advantages mentioned with regard to the system may also apply to the self-propelled harvester.

In one or some embodiments, the computing unit is configured to execute a steering algorithm to automatically steer the harvester, through which the harvester may automatically drive into the plant crop as a function of the determined crop edge and/or may automatically maintain a path when driving into the plant crop. In this way, the driver of the harvester may also be assisted in steering the harvester. In particular, in one or some embodiments, it may be provided that the driver only intervenes manually in the steering when there is a malfunction of the system.

In one or some embodiments, at least one camera of the system is arranged or positioned on a front side of the harvester, such as on a driver's cab, and/or the at least one camera is arranged or positioned on a working unit of the harvester. In any case, however, the camera may be arranged or positioned on the harvester in such a way that the camera may capture image(s) of the front environment of the harvester. Various positions have proven advantageous for this purpose. Depending on the position of the camera, however, a coordinate transformation may be necessary in order to infer the steering angle using the position of the camera and the position of the crop edge. However, in one or some embodiments, if the camera is positioned to the side of the harvester, a coordinate transformation may be omitted.

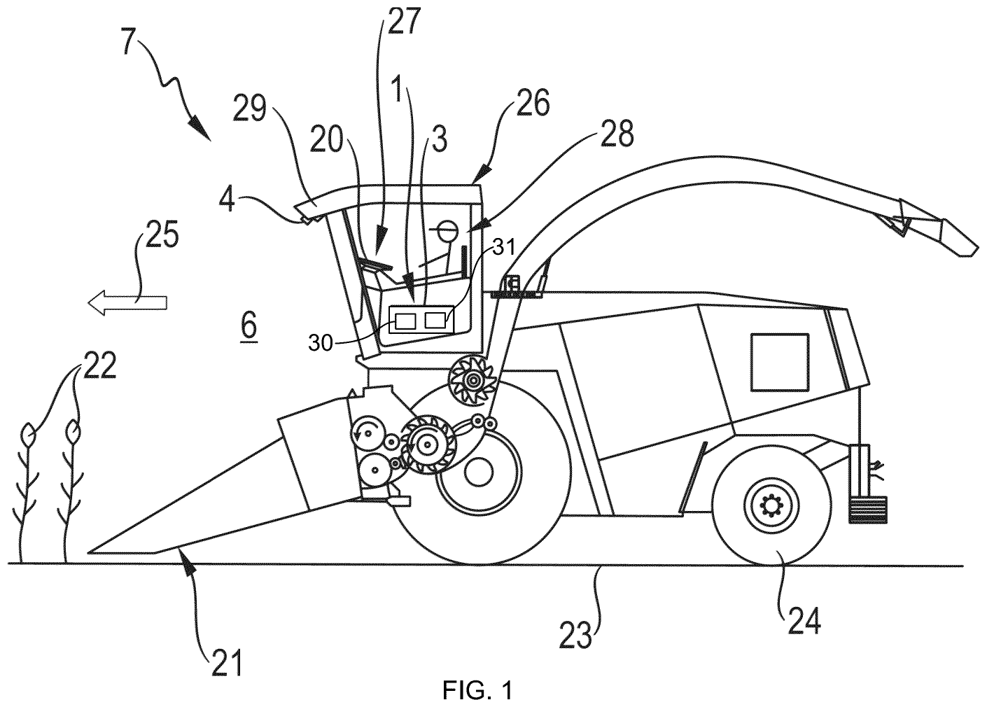

Referring to the figures, a self-propelled harvester 7 illustrated. An example self-propelled harvester is disclosed in US Patent Application Publication No. 2023/0232740 A1, incorporated by reference herein in its entirety. In particular, FIG. 1 illustrates a cutting unit 21 for cutting plants 22 standing in a field 9, and at least two pivotable round wheels 24 in contact with a ground 23. A position of the round wheels 24 may vary for the purpose of changing a direction of travel of the harvester 7. For this purpose, the harvester 7 may comprise a steering wheel 27, which may be operated by a driver 28 of the harvester 7 in order to steer the harvester 7. Furthermore, the harvester 7 comprises a driver's cab 26 from which the harvester 7 may be controlled by the driver 28.

The harvester 7 may be configured to harvest or process a plant crop 10 in a field 9. The harvester 7 may be a forage harvester, for example, which may chop up corn plants standing on the field 9. In order to be able to harvest the plant crop 10 (e.g., the crop), the harvester 7 is steered in the direction of the plant crop 10, wherein the forage harvester is driver over or on a crop edge 2 of the plant crop 10 so that the cutting unit 21 reaches the plants 22.

For this purpose, the harvester 7 comprises a system 1 configured to determine a crop edge 2 of a plant crop 10. The system 1, in turn, may comprise a computing unit 3 and a camera 4 (or other type of image sensor), which may be arranged or positioned on a cab roof 29 of the driver's cab 26 of the harvester 7 and may be oriented with a field of view in the direction of a front environment 6 of the harvester 7. In one or some embodiments, the camera 4 may be oriented to capture images, such as discrete images, of the front environment 6 and to transmit them to the computing unit 3 of the system 1.

Thus, in one or some embodiments, the computing unit 3 may include at least one processor 30 and at least one memory 31 that stores information (e.g., images from camera 4) and/or software to perform the functionality of the computing unit 3 described herein, with the processor 30 configured to execute the software stored in the memory 31, which may comprise a non-transitory computer-readable medium that stores instructions that when executed by processor 30 performs any one, any combination, or all of the functions described herein. In this regard, the computing unit 3 may comprise any type of computing functionality, such as the at least one processor 30 (which may comprise a microprocessor, controller, PLA, or the like) and the at least one memory 31. The memory may comprise any type of storage device (e.g., any type of memory). As shown in FIG. 1, processor 30 and memory 31 are depicted as separate elements. Alternatively, processor 30 and memory 31 may be part of a single machine, which includes a microprocessor (or other type of controller) and a memory. Alternatively, processor 30 may rely on memory 31 for all of its memory needs.

The computing unit 3 is merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

The computing unit 3 may process the images captured or generated by the camera 4. For this purpose, in one or some embodiments, the computing unit 3 may use artificial intelligence in the form of a neural network. In so doing, the artificial intelligence may first segment the individual captured images. In order to determine the crop edge 2 of the plant crop 10, the resulting segments 12 of the images may be assigned to one or more classes, such as to the classes of “plant crop 10” and “background”. Based on the segmentation and classification, the computing unit 3 may define a polygon 13 that runs along a segment boundary 14 between the segments 12 of the two classes.

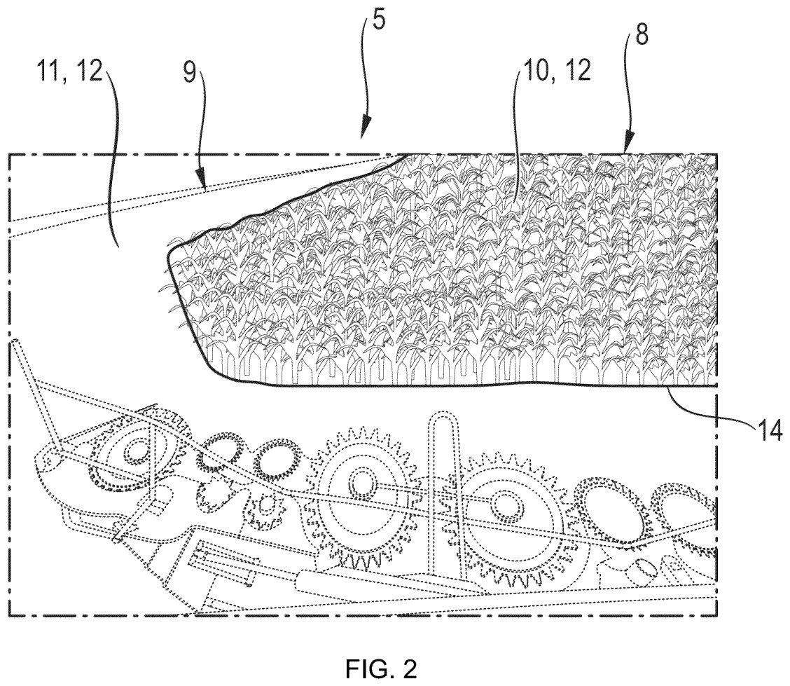

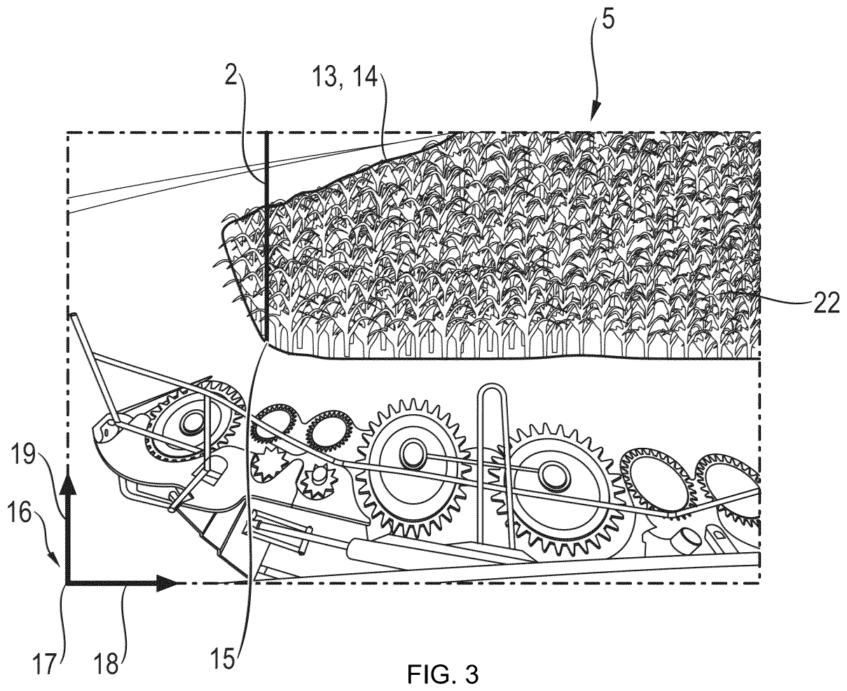

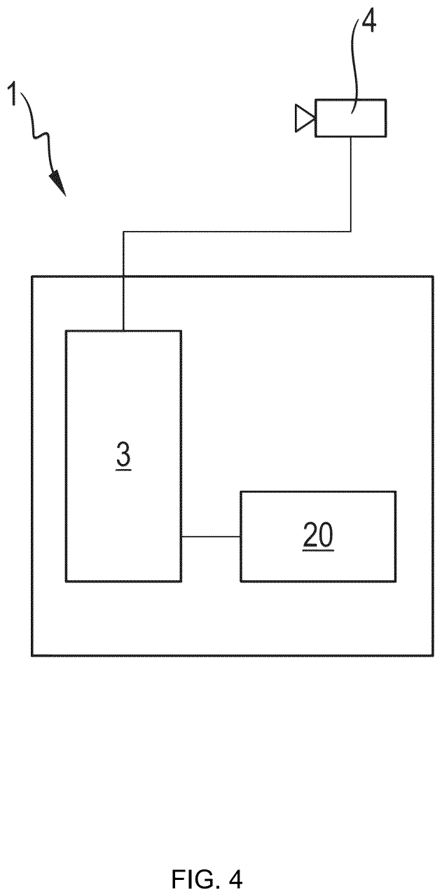

In one or some embodiments, the driver 28 of the harvester 7 may first independently approach the plant crop 10 so that the field of view of the camera 4 captures the plant crop 10, as shown in FIGS. 2 and 3. Subsequently, the driver 28 may activate the system 1 of the harvester 7. For this purpose, the driver 28 may use an entry unit 20 of the harvester 7, which may be located in the driver's cab 26, to define a coordinate cross 16. The entry unit 20 may be in communication with (e.g., wired and/or wirelessly) with the computing unit 3, which in turn may be in communication with the camera 4, as shown schematically in FIG. 4. Further, entry unit 20 may be in communication with the camera 4 (either direct communication or via the computing unit routing the images or the like to the entry unit). In this way, the computing unit 3 may be controlled using the entry unit 20, and wherein the entry unit 20 may receive signals (e.g., images) from the camera 4.

In the field of view of the camera 4 shown in FIGS. 2 and 3, the driver 28 may define a zero point 17 of the coordinate cross 16 in a bottom left corner of the image 5 with an x-axis 18 in a horizontal direction to the right and a y-axis 19 in a vertical direction upward. The system 1 may acquire discrete images of the front environment 6, and thus of the plant crop 10, using the camera 4 and may segment them. As a result, two segments 12 may be formed, wherein the first segment 12 may be assigned to the class of “plant crop 10”, and the second segment 12 may be assigned to the class of “background 11” (or remaining area), as illustrated in FIG. 2. The images may thereby be transferred into a coordinate system so that each pixel of the image 5 may be assigned an x- and a y-pixel coordinate and therefore unambiguously. A coordinate cross 16 may be defined from a zero point 17, which may be located in the bottom left corner of the image in FIG. 1. An x-axis 18 may run in horizontal direction to the right, a y-axis 19 in the vertical direction upwards. Subsequently, based on the segmentation, the computing unit 3 may calculate a polygon 13, which may include the segment 12 of the class of “plant crop 10”. Based on the polygon 13, the computing unit may determine a reference point 15 of the polygon 13. For example, the computing unit 3 may determine the reference point 15 from the pair of pixel coordinates whose sum is the smallest of all pairs of pixel coordinates of the polygon 13.

Starting from the determined reference point 15, the computing unit 3 may define the crop edge 2, which may extend in vertical direction starting from the reference point 15. The crop edge 2 is shown in FIG. 3 with a vertical line over an entire height of the polygon 13.

The computing unit 3 may then send the crop edge 2 to a steering algorithm to automatically steer the harvester 7. In this regard, the crop edge 2 may comprise the one or more instructions generated by the computing unit 3 in order to automatically steer the harvester 7. Thus, the steering algorithm may be suitable for driving the harvester 7 automatically (e.g., without manual intervention) into the plant crop 10 and also for maintaining the direction of the harvester 7 as it continues to travel, in order to be able to optimally harvest the plant crop 10. The harvester 7 therefore may automatically steer into the plant crop 10 and may then continue to maintain the path in the plant crop 10.

If the driver 28 does not agree with the suggested steering angle of the system 1, the operator may deactivate the automatic system by the operator moving the steering wheel 27, so that manual steering is reactivated.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 System
2 Crop edge
3 Computing unit
4 Camera
5 Image
6 Front environment
7 Harvester
8 Planted area
9 Field
10 Plant crop
11 Background
12 Segment
13 Polygon
14 Segment boundary
15 Reference point
16 Coordination cross
17 Zero point
18 x-axis
19 y-axis
20 Entry unit
21 Cutting unit
22 Plant
23 Ground
24 Round wheel
25 Direction of travel
26 Driver's cab
27 Steering wheel
28 Driver
29 Cab roof
30 Processor
31 Memory

1. A system configured to determine a crop edge of a plant crop, the system comprising:
at least one camera configured to generate optical information comprising one or more discrete images of a front environment of an agricultural harvester; and
a computing unit in communication with the at least one camera so that the one or more discrete images are transmitted to the computing unit, the computing unit configured to:
analyze at least one of the one or more discrete images in order to identify a plant crop by using artificial intelligence to delimit a planted area of a field on which the plant crop resides from a remaining residual area of a field;
determine the crop edge of the plant crop based on identifying the plant crop; and
automatically generate, based on the crop edge of the plant crop, one or more control signals in order to automatically control a harvester.

2. The system of claim 1, wherein the artificial intelligence comprises a trained neural network.

3. The system of claim 1, wherein the computing unit is configured to perform a segmentation of the one or more discrete images by means of which content of a respective image is divided into interrelated segments in order to delimit the planted area of the field.

4. The system of claim 3, wherein the computing unit is configured to semantically segment the one or more discrete images; and
wherein the computing unit is configured to assign interrelated segments to different classes in order to divide the respective image into the interrelated segments.

5. The system of claim 4, wherein the different classes comprise a plant crop class and a background class; and
wherein the computing unit is configured to semantically segment the respective image into the different classes in order to determine the crop edge.

6. The system of claim 5, wherein the computing unit is configured to define a polygon based on the respective segments in order to determine the crop edge.

7. The system of claim 6, wherein the computing unit is configured to define the polygon along a segment boundary between the respective segments of the classes plant crop and background.

8. The system of claim 7, wherein the computing unit is configured to determine a reference point of the polygon which, viewed in an image area of a respective image generated by the at least one camera, has a largest or a smallest sum of an x-pixel coordinate and a y-pixel coordinate relative to a defined coordinate cross;
wherein the defined coordinate cross defines an x-axis in a horizontal direction and a y-axis in a vertical direction with reference to the respective image, starting from a zero point; and
wherein the computing unit is configured to control the harvester based on the defined coordinate cross.

9. The system of claim 8, further comprising an entry unit configured to receive one or more entries; and
wherein the computing unit is configured to define the defined coordinate cross based on the one or more entries alternately at different locations and with different orientations of one or both of the x-axis or the y-axis.

10. The system of claim 9, wherein the computing unit is configured to define the defined coordinate cross:
in a bottom left corner of the respective image with the x-axis in a horizontal direction to a right and the y-axis in a vertical direction upwards; or
in a bottom right corner of the respective image with the x-axis in a horizontal direction to a left and with the y-axis in a vertical direction upwards.

11. The system of claim 10, wherein the computing unit is configured to define the crop edge extending in the vertical direction starting from the reference point.

12. The system claim 1, wherein the computing unit is configured to automatically control the harvester by:
transferring the crop edge to a steering algorithm, wherein the steering algorithm, when executed, is configured to automatically steer the harvester so that the harvester automatically performs one or both of automatically entering the plant crop or automatically maintaining a path when driving into the plant crop.

13. A self-propelled harvester comprising:
a cutting unit configured to cut plants standing in a field;
at least two swiveling round wheels in contact with ground, position of at least two swiveling round wheels configured to be changed in order to change a direction of travel of the harvester; and
a system in communication with the at least two swiveling round wheels, wherein the system comprises at least one camera configured to generate optical information comprising one or more discrete images of a front environment of the harvester and a computing unit in communication with the at least one camera so that the one or more discrete images are transmitted to the computing unit, wherein the computing unit configured to:
analyze at least one of the one or more discrete images in order to identify a plant crop by using artificial intelligence to delimit a planted area of a field on which the plant crop resides from a remaining residual area of a field;
determine crop edge of the plant crop based on identifying the plant crop; and
automatically control, based on the crop edge of the plant crop, one or more of the at least two swiveling round wheels so that an alignment of the harvester relative to the plant crop is performed automatically.

14. The self-propelled harvester of claim 13, wherein the computing unit is configured to execute a steering algorithm configured to automatically steer the harvester, through which the harvester is configured to perform one or both of automatically drive into the plant crop as a function of the crop edge or automatically maintain a path when driving into the plant crop.

15. The self-propelled harvester of claim 13, wherein the at least one camera is positioned on one or both of a front side of the harvester or on a working unit of the harvester.

16. The self-propelled harvester of claim 13, wherein the self-propelled harvester comprises a forage harvester.

17. The self-propelled harvester of claim 13, wherein the computing unit is configured to:
perform semantic segmentation of the one or more discrete images by means of which content of a respective image is divided into interrelated segments in order to delimit the planted area of the field; and
assign interrelated segments to different classes in order to divide the respective image into the interrelated segments.

18. The self-propelled harvester of claim 17, wherein the different classes comprise a plant crop class and a background class; and
wherein the computing unit is configured to:
define a polygon along a segment boundary between respective segments of the classes plant crop and background;
determine a reference point of the polygon which, viewed in an image area of a respective image generated by the at least one camera, has a largest or a smallest sum of an x-pixel coordinate and a y-pixel coordinate relative to a defined coordinate cross, wherein the defined coordinate cross defines an x-axis in a horizontal direction and a y-axis in a vertical direction with reference to the respective image, starting from a zero point; and
control the harvester based on the defined coordinate cross.

19. The self-propelled harvester of claim 18, further comprising an entry unit configured to receive one or more entries; and
wherein the computing unit is configured to define the defined coordinate cross based on the one or more entries alternately at different locations and with different orientations of one or both of the x-axis or the y-axis.

20. The self-propelled harvester of claim 19, wherein the computing unit is configured to define the defined coordinate cross:
in a bottom left corner of the respective image with the x-axis in a horizontal direction to the right and the y-axis in a vertical direction upwards; or
in a bottom right corner of the respective image with the x-axis in a horizontal direction to the left and with the y-axis in a vertical direction upwards.
